(19) United States
(12) Patent Application Publication
(10) Pub. No.: US 2024/0189934 A1
(43) Pub. Date: Jun. 13, 2024

(54) Apparatus and Method for Regulating the Position of a Tong-Shaped Tool

(71) Applicant: Robert Bosch GmbH, Stuttgart (DE)

(72) Inventors: Andreas Mader, Michelstadt (DE); Juergen Haeufgloeckner, Schneeberg (DE); Maximilian Wohner, Michelstadt (DE); Sebastian Zeller, Brombachtal (DE)

(21) Appl. No.: 18/523,387

(22) Filed: Nov. 29, 2023

(30) Foreign Application Priority Data
Dec. 8, 2022 (DE) 10 2022 213 307.2

(51) Int. Cl. B23K 11/25; B23K 11/11

(52) U.S. Cl. CPC B23K 11/255; B23K 11/115; B23K 11/253

(57) ABSTRACT

A control apparatus for a welding tool includes a determination module for determining a normalized displacement signal, in which a deflection of a tong-shaped tool, due to an effect of a mechanical force generated on the tool during a work process using the tong-shaped tool, is compensated for. The control apparatus further includes a force regulation module for regulating a progression of the force which the tong-shaped tool applies to at least one component during the work process on at least one component. The force regulation module is configured to regulate the progression of the force during the work process based on the normalized displacement signal.

This application claims priority under 35 U.S.C. § 119 to patent application no. DE 10 2022 213 307.2, filed on Dec. 8, 2022 in Germany, the disclosure of which is incorporated herein by reference in its entirety.

The disclosure relates to an apparatus and a method for regulating the position of a tong-shaped tool, which is in particular a welding tong or a tong for clinching or punch riveting.

### BACKGROUND

Tong-shaped tools are, e.g., used in joining processes such as welding, clinching, riveting, etc., or in the transport of components. Welding tools are used to join metallic parts by welding. For example, in industrial facilities, especially in production lines for vehicles, etc., metallic parts, in particular metal sheets, are joined by welding by means of a welding tool. The welding method performed by the welding tool is in this case controlled or regulated by a welding controller.

Resistance spot welding is one of the most widely used welding methods in automated welding technology and is mainly used in automotive production, especially in the automated body shop for an automobile or other vehicle. In resistance (spot) welding, the components to be welded are pressed together at the point to be welded using two welding electrodes of a welding tong as a welding tool with a predetermined force for a predetermined time. As a result, a circuit is formed, in which a welding lens is formed with a specific progression of an electric current between the components.

Such welding tongs are, e.g., designed as servo-electric welding tongs to apply the force to compress the welding tong to form the spot weld. If the force applied to the welding tong is too great, the welding tong will be damaged. Therefore, the use of a force controller is advantageous in order to meter the force introduced into the welding tong such that no damage occurs to the welding tong or the welding tool.

In resistance (spot) welding, a constant quality of the spot welds is very important in order to be able to meet the requirements for strength and thus the safety of the welded connection produced and thus also of the associated object or product.

Given the increasing requirements for vehicle safety and lightweight construction, there is always a trend towards the use of new materials and/or new coatings for vehicle bodies. In addition, a growing variety of component thicknesses are being used in this context. As a result, the framework conditions for the welded connections to be produced change in each case.

The problem is that a significant decrease in weldability can be observed for components with such new material thickness combinations. Furthermore, this is accompanied by a reduction in the time allowed for welding. The possible process window for the welding process is reduced thereby. In attempts to meet the challenge of achieving the required constant quality of the spot welds, conventional resistance welding systems reached their process limits.

For this reason, the notifying parties considered opening up or expanding the previous regulation with the force as the reference variable by adding additional degrees of freedom. One conceivable solution is the targeted monitoring and regulation of the welding process by means of a displacement signal. The displacement signal indicates the displacement taken by the welding electrodes to produce a welded connection, in particular a spot weld. The displacement signal contains the positions through which the welding electrodes pass for the displacement.

For a stable production process and consistent weld quality, the signal quality of the reference variable is crucial. However, in addition to electrical and mechanical influencing variables, the displacement signal is also influenced by the position or arrangement of a sensor for detecting the displacement signal and the structure for detecting the displacement signal.

The problem is that, for a welding process, optimum detection of the displacement signal is only achieved between the two welding electrodes. In practice, this approach is not practical, as otherwise the detection of the displacement signal would prevent the welded connection from being made. The same applies to joining using the other joining methods mentioned hereinabove. Any other position of the sensor, on the other hand, provides a displacement signal that, when used for a welding process, does not provide the required constant quality of the welded connections.

To solve this problem, the sensor system could, e.g., be attached to the movable tong arm of the welding tong. However, the disadvantage of this is that the displacement signal in this case depends on the mechanical tong configuration as well as the position of the displacement measurement. In other words, each individual mechanical tong configuration must first be detected at great expense in order to obtain a displacement signal that can be used to ensure a stable production process and consistent weld quality. This is particularly disadvantageous for welding tools in which the welding electrodes must be cleaned each time after a predetermined number of welding processes, which changes the mechanical tong configuration.

### SUMMARY

Therefore, the object of the disclosure to provide an apparatus and a method for regulating the position of a tong-shaped tool, using which the problems indicated hereinabove can be solved. Provided in particular are an apparatus and a method for regulating the position of a tong-shaped tool, whereby a regulation of a work process using the tool, which is, e.g., a joining process, in particular a welding process, can be reliably performed despite deflection of the tool, so that a consistently high quality of the working result, e.g. of the joined connection, in particular of the welded connection, can be achieved.

The object is achieved by means of an apparatus for regulating the position of a tong-shaped tool as disclosed herein. The apparatus comprises a determination module for determining a normalized displacement signal in which a deflection of the tong-shaped tool generated by application of a mechanical force (FS(t)) to the tool during a work process using the tong-shaped tool is compensated for, and a force regulation module for regulating a progression of the force which the tong-shaped tool exerts on at least one component during the work process, the force regulation module being designed to regulate the progression of the force during the work process using the normalized displacement signal.

The apparatus described hereinabove offers the possibility for a welding tool to ensure a high and consistent quality of the produced welded connections with a targeted monitoring and regulation of the welding process with the help of the displacement signal. This applies in particular to components with material thickness combinations that could previously only be joined by welding with inadequate results.

For this purpose, the apparatus described hereinabove is very advantageously designed to compensate for the mechanical tong properties and the electrode force with respect to the detected displacement signal.

On the one hand, this means that any joining process, in particular a welding process or other joining process can be monitored and regulated earlier when the cleaned displacement signal is used. Any production-related disturbance variables that occur can be better isolated and detected in the adjusted displacement signal. A reference curve can, e.g., be generated under laboratory conditions and subsequently transferred to production and to other tong configurations.

The apparatus described hereinabove can therefore provide displacement monitoring/regulation for a welding tong type during welding or welding process as a joining process as well as with a reproducible electrode force progression. Nevertheless, this displacement monitoring/regulation can be used alternatively for another (welding) tong type, wherein the same joining quality, in particular welding quality, can be achieved. In this case, changes in the tong type and/or force settings are possible without leading to a displacement discrepancy and thus to a spot weld with poorer quality.

Accordingly, the apparatus described hereinabove makes it possible to transfer a reference displacement progression, once ascertained, to at least one other tong configuration very easily. This also applies if a modified regulation behavior of the force leads to a different displacement progression of the welding electrodes, which is caused by deflection of the tong arms depending on the instantaneous force value.

The apparatus described hereinabove thus compensates during a welding process for the fact that the reference variable “electrode displacement” is dependent on the mechanical tong properties and the force regulation behavior. For this purpose, the weld controller takes into account and compensates for the mechanical tong as well as force properties in the displacement signal in order to implement a target-oriented and system-wide reference variable.

In other words, a joining process, in particular a welding process, can be performed not only with a chronologically variable target force, but also with a chronologically variable target position, which can be individually specified or parameterized by an operator. Automatic parameterization of not only the force regulation module, but also the displacement regulation module is thereby possible. In addition, it is possible to regulate disturbance variables, such as weld spatter or the heat-related expansion of the spot weld.

As a result, there is also no damage to the tong-shaped tool.

As a result, fewer joining processes, especially welding processes, have to be aborted, so that failures of the welding facility in the industrial facility can be minimized. Doing so also both reduces the scrap produced by an industrial facility and increases the output of the industrial facility. In addition, the apparatus significantly improves the service life of the tool. In addition, cost-intensive service calls to rectify faults in a joining facility are required less frequently.

The normalized displacement signal can comprise positions of a displacement to be traveled by an element of the tong-shaped tool during the work process by the tong-shaped tool.

The work process can be a force scaling without a component or a short circuit welding without a component or a cleaning, especially milling, of welding electrode caps of the tong-shaped tool.

In one embodiment, the work process is a joining process for producing a joined connection using the tong-shaped tool, wherein the joining process is a welding process for producing a welded connection using the tong-shaped tool, or is a riveting process or a clinching process. The force regulation module can be designed to regulate the progression of the force when producing the joined connection using the normalized displacement signal.

In one specific embodiment, the determination module is designed to determine the normalized displacement signal Sn(t) from a progression of a force detected in real time and a displacement detected in real time, which an element of the tong-shaped tool covers before and/or during the execution of a joining process.

In yet another specific embodiment, the determination module is designed to determine the normalized displacement signal Sn(t) from a real-time detected progression of a force and a real-time detected displacement that an element of the tong-shaped tool travels to perform the work process.

In one exemplary embodiment, the normalized displacement signal comprises positions of a displacement that an element of the tong-shaped tool has to cover during a joining process in which a joined connection is to be made, or during a service process in which the tong-shaped tool is cleaned or put into operation.

It is conceivable that the determination module be designed to calculate mechanical tong properties of the tong-shaped tool, wherein the determination module is designed to use the mechanical tong properties to determine the normalized displacement signal from the progression of a force detected in real time and a displacement signal detected in real time for the displacement.

In addition, it is possible that the determination module is designed to use mechanical tong properties of a first tong-shaped tool for determining a normalized displacement signal of a second tong-shaped tool, wherein the mechanical tong properties of the second tong-shaped tool differ from the mechanical tong properties of the first tong-shaped tool.

Furthermore, it is possible that the apparatus is designed to evaluate a stiffness model of a joint, wherein the apparatus is designed to abort the currently performed work process if the evaluation of the stiffness model of the joint shows that at least one disturbance variable and/or a predetermined tong wear is/are present.

Optionally, the apparatus is designed to output a message if the evaluation of the stiffness model of the joint shows that at least one disturbance variable and/or a predetermined tong wear are/is present.

The welding control system described hereinabove can be part of a welding facility that further comprises a welding tool that is a welding tong having two electrodes for producing a welded connection on at least one component, a drive device for driving the welding tool in order to apply a force that the two electrodes exert on the at least one component when producing a welded connection, and at least one force sensor attached to a stationary arm of the welding tool and/or a movable arm of the welding tool, the movable arm being movable relative to the stationary arm.

The object is further achieved by means of a method for regulating the position of a tong-shaped tool as disclosed herein. The method comprises the following steps: determining, by means of a determination module, a normalized displacement signal in which deflection of the tong-shaped tool generated by the action of a mechanical force on the tool during a work process using the tong-shaped tool is compensated for, and regulation by means of a force regulation module of a progression of the force which the tong-shaped tool exerts on at least one component during the work process, the force regulation module being designed to regulate the progression of the force during the work process using the normalized displacement signal.

The method achieves the same advantages previously specified with respect to the apparatus.

The step of determining and the step of regulating can be performed at least temporarily during the performance of the work process.

Further possible implementations of the disclosure also include feature combinations or embodiments not described or explicitly specified hereinabove or hereinafter with respect to exemplary embodiments. The skilled person will thereby also add individual aspects as improvements or supplements to the respective basic design of the disclosure.

### BRIEF DESCRIPTION OF THE DRAWINGS

In the following, the disclosure is described in further detail with reference to the accompanying drawings and on the basis of exemplary embodiments. Shown are:

FIG. 1 a highly simplified schematic view of an industrial facility having a welding facility as an example of a joining facility comprising an apparatus according to a first exemplary embodiment, in which a welding controller is used to control a welding tool;

FIG. 2 a sectional view of welding electrodes of the welding tool according to the first exemplary embodiment;

FIG. 3 a simplified representation of a C-welding tong according to the first exemplary embodiment after the welding electrodes have been fed to the at least one component (weld metal) to be welded;

FIG. 4 the C-welding tong in FIG. 3 in a state that occurs when force is applied to the component for or during a welding process or during a service process;

FIG. 5 shows a first example of a welding current chronological progression during a welding process and a normalized displacement signal of the welding electrodes used by the welding controller during the welding process, as well as, in comparison, a displacement signal of the welding electrodes detected in real time during the welding process;

FIG. 6 an enlargement of part of the illustration in FIG. 5;

FIG. 7 a flow chart of a method for determining the mechanical tong properties of the welding tool;

FIG. 8 a flowchart of a method for compensating the mechanical tong properties of the welding tool in a hold-off time for performing a welding process;

FIG. 9 a flow chart of a method for compensating the mechanical tong properties of the welding tool during the welding time of a welding process;

FIG. 10 a flowchart of a method for compensating the mechanical tong properties of the welding tool based on information about disturbance variables during a welding process;

FIG. 11 a flow diagram of a method for performing a service process for the welding tool, in particular cleaning with a cleaning device;

FIG. 12 a simplified representation of an X-welding tong according to a second exemplary embodiment after the welding electrodes have been fed to the at least one component (weld metal) to be welded;

FIG. 13 the X-welding tong in FIG. 12 in a state that occurs when force is applied to the component for or during a welding process or during a service process;

FIG. 14 is a second example of a chronological progression of a welding current during a welding process and a normalized displacement signal of the welding electrodes used by the welding controller during the welding process, as well as, in comparison, a displacement signal of the welding electrodes detected in real time during the welding process;

FIG. 15 an enlargement of part of the illustration in FIG. 14; and

FIG. 16 a simplified representation of a C-welding tong according to a third exemplary embodiment after the welding electrodes have been fed to the at least one component (weld metal) being welded.

In the drawings, identically or functionally similar elements are indicated using identical reference characters, unless otherwise specified.

### DETAILED DESCRIPTION

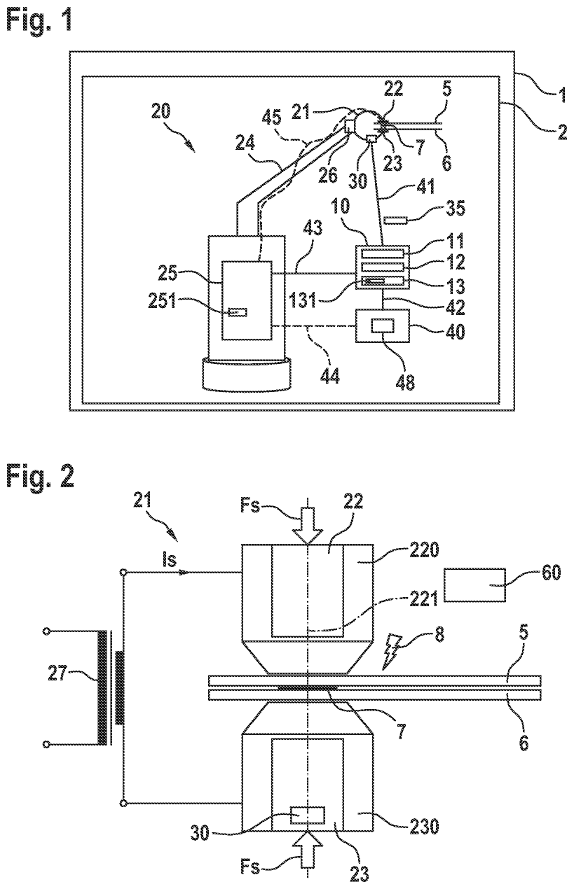

FIG. 1 shows an industrial facility 1 comprising a joining facility 2. In the example in FIG. 1, the joining facility 2 is a welding facility used for welding at least one metallic component 5, 6. The at least one metallic component 5, 6 is in this case joined with at least one welded connection 7. The at least one welded connection 7 is, e.g., a spot weld and/or a weld seam. The two metallic components 5, 6 or just two edges of one of the components 5, 6 can be joined together.

The industrial facility 1 is, e.g., a production line for vehicles, furniture, buildings, etc., in which the metallic components 5, 6 are welded. For this purpose, the welding facility 2 has a control apparatus 10, which is also called a welding controller, an apparatus 20 for guiding a welding tool 21 designed as a resistance welding tool with two welding electrodes 22, 23, a detection device 30 and an operating device 40. The apparatus 20 is controlled by a control device 25. In addition, communication lines 41 to 45 are provided, which can be designed in particular as a bus system. Messages 48 can be output by the operating device 40, in particular status messages and/or error messages and/or other information.

The control apparatus 10 is an apparatus for regulating the position of the welding tool 21, which is a tong-shaped tool.

In particular, the apparatus 20 is a robot. The operating device 40 is, e.g., feasible as a keyboard and/or a mouse, a laptop, a touch-sensitive or touch-insensitive screen, etc., or combinations thereof.

As shown in FIG. 1, the welding tool 21 is a welding tong with at least one electrode 22, 23. In particular, the welding tool 21 is a servo-electric welding tong. In the example in FIG. 1, the welding tong is designed as a C-tong. It is in this case possible that one of the tong arms, at the end of which the electrode 22 is arranged, e.g., is a movable tong arm and the other tong arm, at the end of which the electrode 23 is arranged, e.g., is a stationary tong arm. In this context, the term “stationary” means that the stationary tong arm is not directly drivable into movement relative to the movable arm. Instead, the moving arm is driven directly. The detection device 30, in particular its force sensor, can be provided on at least one of the arms. The electrodes 22, 23 are preferably designed as water-cooled electrode shafts.

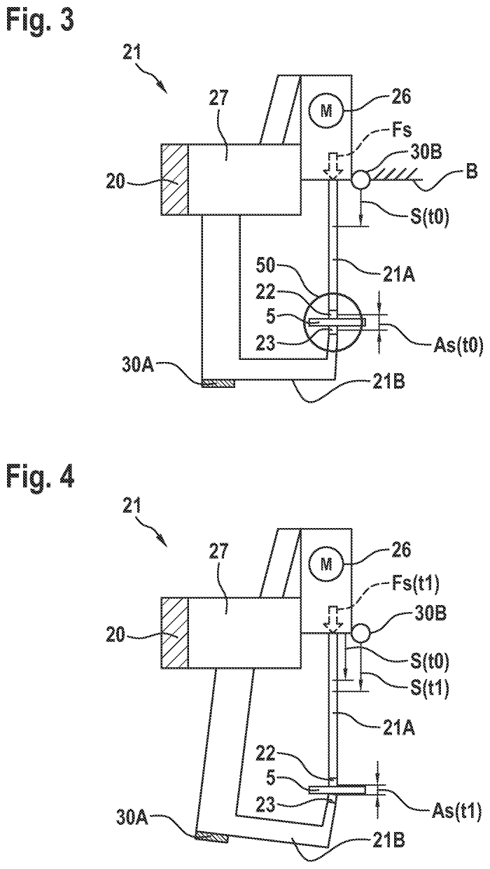

The welding controller 10 is used to control the welding tool 21. Therefore, the control apparatus 10 is connected to the welding tool 21 or its electrical components via the communication line 41. The control apparatus 10 is also connected to the operating device 40 via the communication line 42. In addition, the control apparatus 10 receives, via the communication line 41, data 35 detected by the detection device 30 during operation of the welding tool 21. For this purpose, the detection device 30 comprises at least one sensor for detecting physical quantities that are relevant during welding and are referred to below as the data 35. Such physical quantities or data 35 comprise, in particular, a holding and/or pressing force Fs for holding the welding tool 21 against the at least one component 5, 6 and/or pressing the electrodes 22, 23 against the at least one component 5, 6 when performing a welding process to produce a welded connection 7. The detection device 30 therefore comprises in particular at least one force sensor. In addition, at least one other sensor can be comprised, as described in more detail hereinafter with respect to FIG. 3 and FIG. 4.

The control apparatus 10 has a determination module 11, a force regulation module 12, and a memory module 13. The force regulation module 12 uses data 35, 131 for the force FS stored in the memory module 13, as described in further detail hereinafter.

For controlling a welding process using the welding tool 21, the control apparatus 10, more specifically its memory module 13, also stores internal basic parameters or target values or data 131 that can be entered by a user either at the place of production or later by means of the operating device 40. The internal basic parameters or target values 131 can be parameters of the welding tool 21. In addition, the internal basic parameters or target values 131 can be parameters of the control apparatus 10 used to control the welding tool 21. In particular, the internal basic parameters or target values 131 are a phase angle of a welding current Is and/or a resistance R of the welding tool 21 and/or the holding and/or pressing force Fs. The welding current Is is supplied to the welding tool 21 by a welding transformer (not shown in FIG. 1). This is described in more detail with reference to FIG. 2. All internal basic parameters or target values 131 can be stored as chronologically dependent variables or target chronological progressions of the respective target values. Thus, in particular a welding current Is(t) and/or a resistance R(t) of the welding tool 21 and/or the holding and/or pressing force Fs(t) can be stored. Continuous chronological progressions or intermittently defined chronological progressions can be stored.

When guiding the welding tool 21 with an arm 24 of the apparatus 20, the apparatus 20 is controlled by its control device 25. For this purpose, the control device 25 is connected to the control apparatus 10 via the communication line 43. Optionally, the control device 25 is connected to the operating device 40 via a communication line 44. The welding tool 21 is opened or closed by driving a drive device 26.

Additionally or alternatively, the control device 25 is directly connected to the detection device 30 and/or the electrical components of the welding tool 21 by means of a communication line 45. If there is no redundancy requirement, it is possible to omit communication line 43.

The communication lines 42 to 45 can be used to exchange relevant data for performing a weld using the welding tool 21 between the control apparatus 10 and the apparatus 20, more specifically the control device 25, and/or the operating device 40. In addition, internal basic parameters or target values 251 of the control device 25 can be stored in the control device 25, with which the welding tool 21 is controlled, in particular for its positioning in space and therefore on the components 5, 6.

FIG. 2 shows the structure of the electrodes 22, 23 of the welding tool 21 in more detail in the present exemplary embodiment. Accordingly, the electrode 22 is formed as an electrode shaft provided with an electrode cap 220 at one end thereof. The electrode cap 220 is arranged on the electrode 22 at its end facing the component 5. In addition, the electrode 23 is formed as an electrode shaft provided with an electrode cap 230. The electrode cap 230 is arranged on the electrode 23 at its end facing the component 6.

The welding tool 21 can be processed by a cleaning device 60, shown very schematically, in such a way as to eliminate the dirty part of one of the electrode caps 220, 230. Consequently, the electrode caps 220, 230 are wear objects. The cleaning device 60 can be a replacement device for replacing the electrode caps 220, 230 or can be a milling and/or cutting device for cutting or milling off the soiled portion of one of the electrode caps 220, 230 as needed.

During operation of the welding tool 21, the electrodes 22, 33 are arranged at a point to be welded (joint) to the at least one component 5, 6 and are applied to the at least one component 5, 6 by means of a holding and/or pressing force Fs. In other words, the two electrodes 22, 23 clamp the components 5, 6 with the force Fs. Here, the electrodes 22, 23 are to be fed to the at least one component 5, 6 to different extents depending on the number of milling and/or cutting processes already performed on the electrode caps 220, 230 in order to achieve the desired force Fs. A welding current Is is then supplied to the electrodes 22, 33 by means of a welding transformer 27 for a predetermined period of time T and in a predetermined characteristic. For this purpose, the current Is is supplied with a defined current progression, in particular at least partially regulated. As a result, heat is generated in the at least one component 5, 6 so that a welding lens is formed, which later forms the welded connection 7. As a result, the at least one component 5, 6 is joined by a joining process. The at least one component 5, 6 is joined.

During welding, disturbance variables 8 can occur, such as weld spatter and/or a gap can develop in one of the joining planes between the components 5, 6 and/or a misalignment of the components 5, 6 can occur and/or undesirable changes in a predetermined hold-off force of the force Fs and/or the welding current Is can result over time t. In addition, the welding process can be undesirably interrupted too early.

The control apparatus 10 in FIG. 1 is also capable of compensating for such disturbance variables 8, as described hereinafter.

FIG. 3 shows a simplified illustration of the welding tool 21 on the apparatus 20. The welding tool 21 is designed as a servo-electric C-welding tong. For this purpose, the welding tool 21 has a movable arm 21A, a stationary arm 21B, a drive device 26, a welding transformer 27, and as part of the detection device 30 in FIG. 1, a force sensor 30A and a position and/or displacement sensor 30B. The arrangement of the two electrodes 22, 23 with respect to each other forms a reference system 50 for detecting, e.g., a distance As(t0) between the electrodes 22, 23 for the control apparatus 10 in FIG. 1.

In FIG. 3, there is a component 5 between the electrodes 22, 23 on which a welded connection 7 is to be made, as described in more detail previously with reference to FIG. 1 and FIG. 2. The welding transformer 27 with attached rectifier is arranged between the drive device 26 and the stationary arm 21B.

The drive device 26 in FIG. 3 uses a motor, in particular an electric motor, to drive the movable arm 21A in order to move it translationally. For this purpose, the motor performs a predetermined number of revolutions n or −n, thereby generating a torque M that acts on the arm 21A. As a result, the movable arm 21A is moved towards or away from the stationary arm 21B or the at least one component 5. The position and/or displacement sensor 30B detects the displacement covered by the movable arm 21A relative to a reference point B during infeed or return. For this purpose, the position and/or displacement sensor 30B is arranged in or on the drive device 26 and/or the movable arm 21A. The position and/or displacement sensor 30B can be implemented as a resolver/absolute value encoder or as an incremental encoder of a servo motor of the drive device 26. Additionally or alternatively, in an inductive drive, the air gap of an electromagnet can be used to indirectly detect the travelled displacement of the movable arm 21A relative to a reference point B. Alternatively or additionally, the position and/or displacement sensor 30B detects the current position of a predetermined location on the movable arm 21A.

FIG. 3 shows the state for a time to in which the two arms 21A, 21B with the electrodes 22, 23 are arranged on the component 5, but no pressing and holding force FS is yet acting on the component 5. Therefore, FS or FS(t0)=0. The position and/or displacement sensor 30B therefore outputs a displacement signal S(t0) corresponding to the distance As(t0) in the reference system 50. To make the welded connection 7 in FIG. 2, the drive device 26 drives the movable arm 21A even further in the direction of the component 5 and thus the stationary arm 21B.

As shown in FIG. 4, this causes a predetermined pressing and holding force FS(t1) to act on the component 5 and between the electrodes 22, 23 at a time t1. At time t1, the electrodes 22, 23 are thus spaced apart at the distance As(t1), which is smaller than the distance As(t0). The force FS(t1) causes the tong arms 21A, 21B to deflect, as can be seen from the comparison in FIG. 3 and FIG. 4. In the example in FIG. 4, the deflection has shifted the stationary tong arm 21B from its position in FIG. 3 to the position in FIG. 4. After the start of a welding process, the distance between the electrodes 22, 23 changes dynamically.

Thus, the position and/or displacement sensor 30B outputs a variable displacement signal S(t) over time t for the displacement that the movable arm 21A travels between the state in FIG. 3 to the state in FIG. 4. FIG. 4 illustrates the difference of the displacement signal S(t1) at time t1 compared to the displacement signal S(t0) at time t0. The displacement signal S(t) includes the deflection of the tong arms 21A, 21B. In contrast, only the elastic/plastic deformation of the material to be welded of the component(s) 5, 6 and/or the elastic/plastic deformation of the electrodes 22, 23 is included in the reference system “As”. The time t1 is an arbitrarily selectable time during a welding process.

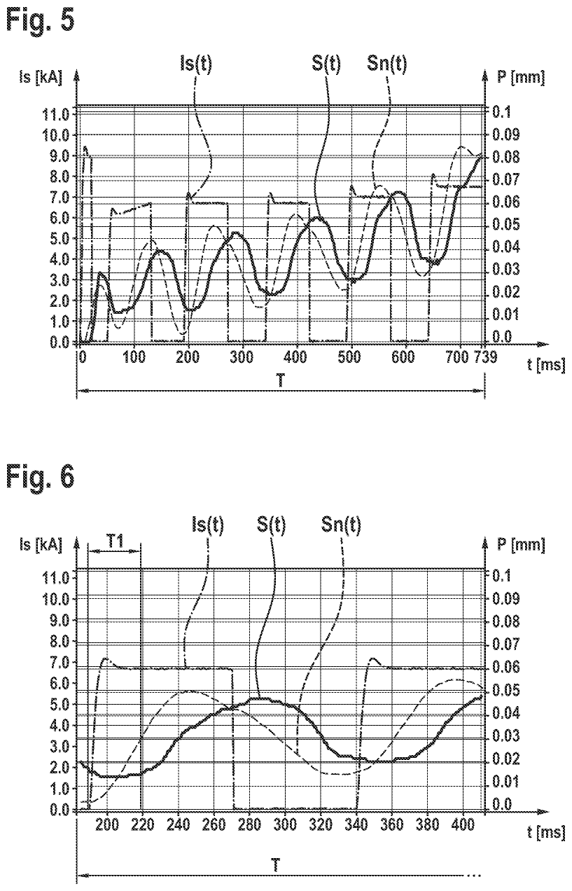

Even more, the mechanical stiffness of the arms 21A, 21B during the subsequent welding process has an influence on the welding result and thus on the quality of the welded connection 7 to be produced in FIG. 2. This is described in more detail with reference to FIG. 5.

FIG. 5 shows a welding current Is(t) with an intermittent progression over time t in ms. The welding current Is(t) is supplied to the electrodes 22, 23 to perform a welding process for a period of time, which is also referred to as the welding time T in the following. The vertical axis on the left in FIG. 5 indicates the respective values or amplitudes Is for the welding current Is(t) in kA. In addition, FIG. 5 shows the resulting displacement signal S(t) that the sensor 30B detects in real time over time t. In comparison, a normalized displacement signal Sn(t) is shown, which the control apparatus 10 generates over time t as a reference variable for regulating the welding process. The vertical axis on the right in FIG. 5 indicates the respective positions P of the electrode 22 on the movable arm 21A in mm for the signals S(t), Sn(t). The signal S(t) reflects the “raw signal”, i.e. the acquired or detected displacement of the sensor 30B. The normalized signal Sn(t) reflects the relative movement of the electrodes 22, 23 to each other.

The control apparatus 10 can use the normalized displacement signal Sn(t) to regulate the welding current Is(t) and/or the force FS(t) during a welding process using the welding tool 21. This compensates for the influence of the mechanical properties of the tong system of the welding tool 21.

FIG. 6 shows an enlarged view for the period up to 400 ms to further illustrate the differences between the signals S(t), Sn(t). The displacement signal Sn(t), which the control apparatus 10 generates over time t as a reference variable for the regulation of the welding process, compensates for the influences described hereinafter on the chronological progression of the displacement signal S(t) detected in real time. The displacement signal Sn(t) makes it possible to check and regulate the welding process in the initial time T1 of the welding process.

Based on FIG. 5 and even better on FIG. 6, the influence of the tong stiffness at the beginning of the welding time T is apparent. The effect and cause of this influence is that the welding current Is(t) initially leads to heating of the component 5, especially during the period of time T1, and thus to expansion of the component(s) being joined. The resulting electrode force or force FS(t), which leads to suppression of a change in displacement signal S(t), is thereby increased. Therefore, it is not possible to check and regulate the welding process based on the displacement signal S(t) in the initial time of the welding process. In particular, the initial time is equal to the period of time T1. The initial time can be up to 30 ms.

In addition, the tong stiffness has an influence during welding, as follows. During the course of the welding process, both the expansion of the at least one component 5 and the sinking of the electrodes 22, 23 into the at least one component 5 or the joining partners lead to a change in the force FS(t) and thus to the deflection up and/or stretching of the tong system of the welding tool 21. A change of the force FS(t) always leads to a change of the displacement signal S(t) compared to the reference system 50 (distance of the electrodes 22, 23 to each other).

As shown in FIG. 5 and FIG. 6, the set force FS(t) between the electrodes 22, 23 during welding (welding process) is subject to high or large dynamics caused by the heating and expansion of the material to be welded of the at least one component 5. The following applies in this regard.

In the case of a constant welding current Is(t), an expansion of the at least one component 5 (weld metal) occurs during the current flow at the beginning of the welding time T, or at the beginning of a pulse of an intermittent welding current Is(t). This results in an increase or rise of the displacement signal S(t). During the current flow at the end of the welding time T, or at the end of a pulse of an intermittent welding current Is(t), there follows a sinking, in particular a slight one, of the electrodes 22, 23 into the at least one component 5 due to softening of the material. This results in a drop or reduction of the displacement signal S(t).

With the intermittent welding current Is(t) in FIG. 5 and FIG. 6, pause times occur for the current flow, in which Is(t)=0. During the pause times, shrinkage of the at least one component 5 (weld metal) takes place. This results in a drop or reduction of the displacement signal S(t) detected in real time.

Due to the tong properties and force variations, the displacement signal S(t) has a discrepancy with the reference system 50. The displacement increases in the displacement signal S(t) are offset in the pause time (Is(t)=0) and do not feature the same amplitude over the entire period of the welding time T.

In contrast, according to FIG. 5 and FIG. 6, the displacement signal Sn(t) generated by the control apparatus 10 has improved dynamics compared to the displacement signal S(t) detected in real time. The displacement signal Sn(t) generated by the control apparatus 10 provides values as early as 20 ms after the start of the welding time T, which the control apparatus 10 can use to regulate the welding process. As a result, the welding process can be regulated earlier with the signal Sn(t) than with the displacement signal S(t) detected in real time. In addition, the displacement signal Sn(t) generated by the control apparatus 10 provides direct feedback during the pause times when Is(t)=0.

The displacement signal Sn(t) generated by the control apparatus 10 compensates for the deflection of the welding tool 21 in the displacement signal S(t). The displacement signal Sn(t) represents the relative movement of the electrodes 22, 23 to each other.

Therefore, the displacement signal Sn(t) generated by the control apparatus 10 deviates much less than the displacement signal S(t) detected in real time from a displacement signal (not shown), which is detectable with a triangulation sensor between the electrodes 22, 23. Therefore, the displacement signal Sn(t) generated by the control apparatus 10 can also be called normalized displacement signal Sn(t). If the control apparatus 10 uses the normalized displacement signal Sn(t) in regulating the welding process, it is also possible to achieve (approximately) the same spot diameter for a welded connection 7 in each case, even for different types of tong, e.g. C-tong or X-tong or tongs with different geometries. This is only possible if the compensation of the mechanical tong properties Z has been successfully performed.

Due to the compensation performed by the control apparatus 10, characteristic position points of the displacement signal Sn(t), such as rise of the displacement signal Sn(t) (displacement rise) or maxima of the displacement signal Sn(t) (displacement maxima), can be detected earlier. In addition, critical displacement maxima, where there is a risk of weld spatter, e.g., as is particularly the case when welding steel, can be detected earlier and in real time and compensated for if necessary.

The welding process/welding operation can only be regulated by means of the compensated/normalized displacement signal Sn(t), since the arm deflection of the tool 21 is a multiple, in particular a factor of 20, of the process signal, in particular the force signal Fs(t). The normalized displacement signal Sn(t) compensates for deflection in the position signal or displacement signal S(t) caused by unwanted force fluctuations (disturbance variables, gap, misalignment, regulation interventions, softening of the signal, etc.) or force profiles.

Likewise, the probability for the location of a gap in the joining plane (non-specified multi-sheet connection) can be specified, since the elastic/plastic deformation of the component 5, 6 is reflected in the overall stiffness.

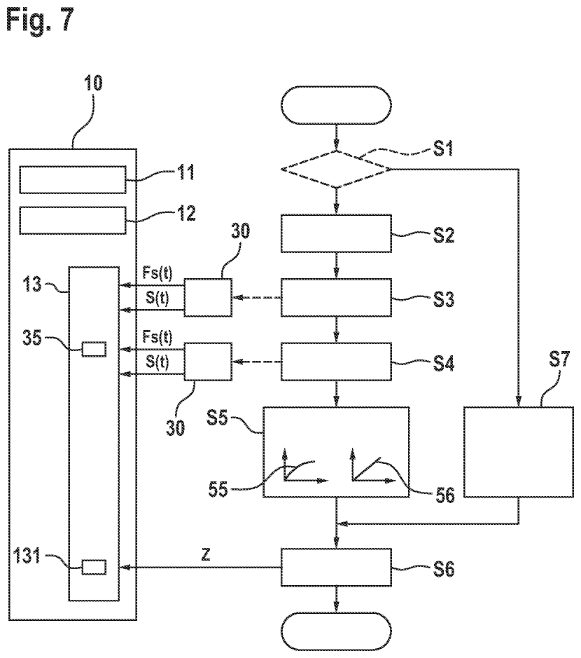

For this purpose, the control apparatus 10 proceeds to ascertain the displacement signal Sn(t) the displacement signal S(t) detected in real time, as illustrated in FIG. 7 to FIG. 10.

The method in FIG. 7 performs the control apparatus 10, in particular with its determination module 11 and force regulation module 12, for determining the mechanical tong properties Z of the welding tool 21. The method is performed at least once before welding using the welding tool 21 in production. The method can be performed by the control apparatus 10 when the welding tool 21 is put into operation.

Optionally, however, the control apparatus 10, in particular with its determination module 11 and force regulation module 12, can additionally perform the method in FIG. 7 with predetermined intervals. This is particularly advantageous for determining the wear of the welding tool 21 over its useful life, during which, e.g., the electrode caps 220, 230 (FIG. 2) become contaminated and thus have to be cleaned or milled off using the cleaning device 60 (FIG. 2). Such intervals can be set for performing a short-circuit measurement in which the electrodes are in contact with each other without component 5, 6 in between, or for a manufacturing process for producing an object on which multiple welded connections 7 are to be made, or per previously performed analytical or numerical simulation of the tong configuration in which the stiffness and damping coefficients of the mechanical system are ascertained, as previously described with respect to step S21. For an in-situ determination procedure, the “numerical or analytical simulation” version can be omitted. The intervals can be defined by an expiration of a predetermined period of time. Alternatively or additionally, the intervals can be defined by a predetermined number of welding processes or welded connections 7 that have already been performed.

The basis of the system in FIG. 3 and FIG. 4 and thus of the method in FIG. 7 is the simplified illustration or assumption of the welding tong as a single-mass oscillator. By means of of the installed displacement and force sensors of the detection device 30, the characteristic values of the tong stiffness of the tool 21 are ascertained in certain chronological cycles. In order to describe reference system 50, the “distance between electrodes”, the recorded detection signal is offset by the expected deflection/stretching of the system during the welding process. This makes it possible, with a measurement setup used in industry, to describe the relative position change between electrodes 22, 23. This is described in more detail hereinafter.

After starting the method in FIG. 7, in step S1, the control apparatus selects a determination mode for determining the mechanical tong properties Z of the welding tool 21. The control apparatus 10 can perform the selection depending on the type of welding tool 21, in particular C-tong or X-tong, and/or depending on already stored basic parameters 131 and/or using at least one input of a user of the operating device 40. It is in this case possible to select between experimental determination modes for determining the mechanical tong properties Z of the welding tool 21 or computational determination modes for determining the mechanical tong properties Z of the welding tool 21.

Experimental determination modes include, e.g., performing a scaling of the force Fs(t) without a component 5, 6 being present between the electrodes 22, 23, performing a short-circuit weld in which no component 5, 6 is present between the electrodes 22, 23 during welding, an in-line determination comprising performing a welding process in which at least one component 5, 6 is present between the electrodes 22, 23 during welding.

Computer determination modes for determining the mechanical tong properties Z of the welding tool 21 include, e.g., performing a numerical simulation or performing an analytical calculation of the tong geometry of the welding tool 21. In particular, the tong geometry comprises the dimensions, e.g. length and thickness, of the tong arms 21A, 21B, the design of the tong arms 21A, 21B, the dimension and design of the electrodes 22, 23, etc. Step S1 is optional. Step S1 can be omitted if only one determination mode for determining the mechanical tong properties Z of the welding tool 21 is implemented in the control apparatus 10.

If an experimental determination mode was selected in step S1, then the flow proceeds to step S2. If, on the other hand, a computational determination mode has been selected, the flow proceeds to step S7.

In step S2, the control apparatus 10 controls the drive device 26 to move the electrodes 22, 23 together. For this purpose, e.g., the movable electrode 22 is fed to the stationary electrode 23. After starting the control, the flow continues to step S3.

In step S3, in particular with the control apparatus 10, e.g. with the force regulation module 12, a detection is started with the detection device 30 to detect the force signal Fs(t) and the displacement signal S(t) in real time. The detection device 30 sends the detected signals Fs(t), S(t) to the memory module 13 for storage of the signals as part of the data 35. In addition, the control apparatus 10 checks, in particular using the force regulation module 12, whether the detected force signal Fs(t) is still less than 0 N or not. If the detected force signal Fs(t) is greater than 0 N, the flow continues to step S4.

In step S4, the control apparatus 10, e.g. using the force regulation module 12, regulates the force value of the detected force signal Fs(t) to a predetermined force value. If there is no component 5, 6 between the electrodes 22, 23, the electrodes 22, 23 directly exert the detected force Fs(t) on each other. If a component 5, 6 is present between the electrodes 22, 23, the electrodes 22, 23 exert the detected force Fs(t) on each other via the component 5, 6. After that, the flow continues to step S5.

In step S5, the control apparatus 10, in particular its determination module 11, uses the ascertained tong parameters to determine a relationship (regression) between the signals Fs(t), S(t). Here, it is first determined whether the relationship between the force signal Fs(t) and the displacement signal S(t) is an m-ter-order relationship, as shown in FIG. 7 with progression 55, or whether the relationship between the force signal Fs(t) and the displacement signal S(t) is a linear relationship, as shown in FIG. 7 with progression 56. During the progressions 55, 56 in FIG. 7, the force signal Fs(t) is plotted on the vertical axis and the displacement signal S(t) is plotted on the horizontal axis. For a m′th arrangement or a progression 55 relationship, control apparatus 10, in particular its determination module 11, uses the following Equation (1):

Xₘ=C₁F+C₂F²+ . . . +CₘF^{m}+n (1)

in order to use the change in position x of the tong arm(s) 21A, 21B and/or electrode(s) 22, 23 ascertained from the displacement signal S(t) and the force F ascertained from the force signal Fs(t) due to the stiffness of the welding tool 21 to determine the tong stiffness factors c1 to cm of Equation (1). In this case, m is a natural number greater than or equal to 1. F stands for the current or instantaneous force. The parameter n is an optional constant that represents the offset of Equation (1). The offset is determined by the intersection of the current Is(t) or the displacement signals S(t), Sn(t) with the vertical axis (ordinate) in FIG. 6 or FIG. 7. In principle, n is not necessary. The maximum order of Equation (1) is determinable by a user of the apparatus 2 or the facility 1. As a result of the coefficient of determination R2 for the regression, the apparatus 10 calculates the most appropriate order of the relationship according to Equation (1) (regression equation).

For a linear relationship or progression 56, where m=1, the control apparatus 10, in particular its determination module 11, uses the following Equation (2) to determine the tong stiffness factor c:

X₁=cF+n (2)

Optionally, the control apparatus 10, in particular its determination module 11, additionally determines the tong damping factors for the tong properties Z using the following

### Equation (3):

$$( \ddot{x} + \frac{k}{m} \dot{x} + \frac{c}{m} x = 0 ) \qquad ( 3 )$$

In Equation (3), k stands for a damping factor that is multiplied by the first derivative of the position change x. The second derivative of the position change x enters Equation (3) unchanged. Otherwise, the same parameters/variables apply as already mentioned with respect to Equations (1) and (2).

After determining the tong properties Z n step S5, the flow proceeds to step S6.

In step S6, the control apparatus 10, in particular its memory module 13, stores the tong characteristics Z ascertained in step S5 as basic parameters 131 in the memory module 13.

The method in FIG. 7 is then terminated.

If a computational determination mode was selected in step S1, the tong properties Z are determined in step S7. For this purpose, the control apparatus 10, in particular its determination module 11, uses the aforementioned Equation (1) to determine the tong stiffness factors c1 to cm. Optionally, the control apparatus 10, in particular its determination module 11, additionally uses the aforementioned Equation (3) to also determine the tong damping factors.

After determining the tong characteristics Z in S7, the flow proceeds to step S6 in which the tong characteristics Z ascertained in step S7 are stored as basic parameters 131 in the memory module 13.

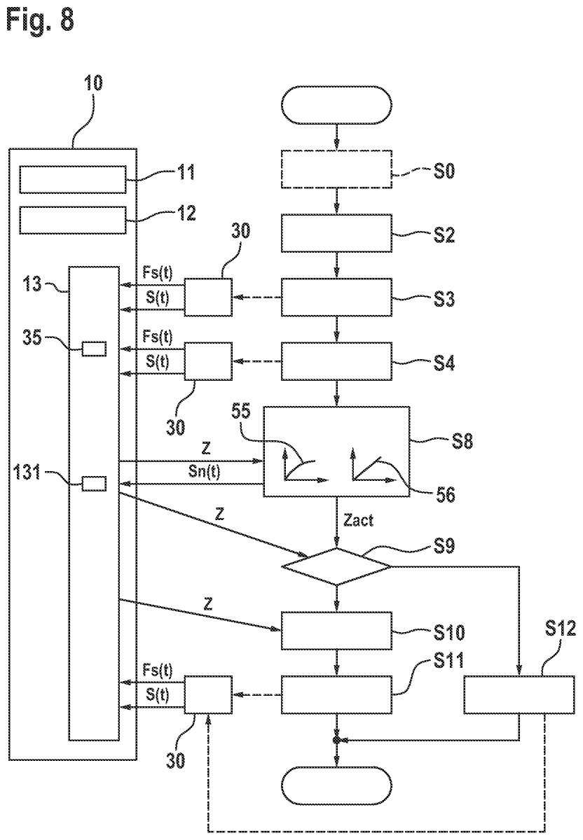

After that, a welding process using the welding tool 21 can begin. The control apparatus 10 proceeds as illustrated in FIG. 8.

According to FIG. 8, an optional step S0 is performed after the start of the method. In step S0, a process flow in a manufacturing of an object is started and/or at least partially performed. Such a process sequence could be that a bodyshell is fed to an apparatus 20 by means of a transport device and/or the apparatus 20 and/or the welding tool 21 is moved to the bodyshell. After that, the flow continues to step S2.

In step S2, the subsequent step S3 and the subsequent step S4, the procedure is as described with reference to FIG. 7. Accordingly, the welding tool 21 is arranged on at least one component 5, 6 and a force Fs>0 N is applied so that the predetermined force Fs is reached with which a welding process is to be started. The flow then continues to step S8.

In step S8, a calculation is performed in the hold-off time of the welding process. Accordingly, no welding current Is is yet supplied to the electrodes 22, 23, but the control apparatus 10, in particular its determination module 11, performs a calculation to compute the current tong characteristics Zact. For this purpose, the control apparatus 10, in particular its determination module 11 and/or force module 12, uses the tong characteristics Z stored in the memory module 13 and/or performs a regression between the force signal Fs(t) and the displacement signal S(t) ascertained in steps S3 and S4 in FIG. 8. The control apparatus 10, in particular its determination module 11, determines the respective positions x using the tong properties Z as well as the force signal Fs(t) and the displacement signal S(t), and forms the displacement signal Sn(t) from these. A first example of this displacement signal Sn(t) is shown in FIG. 5 and FIG. 6, as described previously. The flow then continues to step S9.

In step S9, the control apparatus 10, in particular its determination module 11, checks whether the current tong characteristics Zact differ from the tong characteristics Z stored in the memory module 13. The control apparatus 10 thus compares the current tong characteristics Zact with the tong characteristics Z stored in the memory module 13. If the tong characteristics Z are different from the current tong characteristics Zact, the flow proceeds to step S10. Otherwise, i.e., if there is at least one difference between the tong properties Z and the current tong properties Zact that is within a predetermined tolerance range, the flow proceeds to step S12.

In step S10, the control apparatus 10, in particular its determination module 11, performs a disturbance consideration. The control apparatus 10 ascertains whether the current tong characteristics Zact are unequal to the tong characteristics Z+/−a predetermined tolerance stored in the memory module 13. The control apparatus 10 thus ascertains whether or not the difference between current tong characteristics Zact and the tong characteristics Z stored in the memory module 13 is within a predetermined tolerance band. If the difference is not within the predetermined tolerance band, the control apparatus 10 outputs a message 48, in particular a warning message, by means of the operating device 40 (FIG. 1) and proceeds to step S11. Otherwise, i.e., if the difference is not within the predetermined tolerance band, the flow proceeds to step S11 without message 48, in particular warning message.

In step S11, the control apparatus 10, in particular its current and/or force regulation module 12, performs a welding process with the welding time T using the force signal Fs(t) and the displacement signal S(t) detected in real time as the command variable for the current and/or force regulation. Accordingly, a welding current Is(t) is supplied to the electrodes 22, 23, as shown, e.g., in FIG. 5 and FIG. 6 and described previously. The control apparatus 10 thus performs no compensation for the current tong characteristics Zact. The signals Fs(t) and S(t) detected during the welding process, in particular in real time, are stored in the memory module 13.

The method in FIG. 8 is then terminated. Alternatively, the flow can go back to step S0.

In step S12, the control apparatus 10, in particular its current and/or force regulation module 12, performs a welding process with the welding time T using the force signal Fs(t) and the displacement signal Sn(t) generated in step S8 as a command variable for the current and/or force regulation. Accordingly, a welding current Is(t) is supplied to the electrodes 22, 23, as shown, e.g., in FIG. 5 and FIG. 6 and described previously. The control apparatus 10 thus performs a position compensation and thus compensation of the current tong characteristics Zact, in that the control apparatus 10 does not use the displacement signal S(t) detected in real time as the command variable for the current and/or force regulation, but uses the displacement signal Sn(t) generated in step S8. The signals Fs(t) and S(t) detected during the welding process, in particular in real time, are stored in the memory module 13.

The control apparatus 10 therefore enables detection and regulating of disturbance variables 8 (FIG. 2) in the at least one component 5, 6 or the joining partners, which are in particular made of sheet metal. For this purpose, the control apparatus 10, in particular its memory module 13, stores the material quality and thickness of the component(s) 5, 6 to be welded. Due to the different mechanical strain-stress diagrams and thus presently or currently existing tong properties Zact, the compensation of the gap and thus the component 5, 6, in particular sheet metal, in the joining plane can be ascertained. This is very advantageous, since in the case of connections between multiple layers of a component 5 or multiple components 5, 6 or joining partners which have different material grades and/or thicknesses, it is not possible to detect in which joining planes any disturbance variables are present. The mechanical influencing variables of the tong configuration are in this case superimposed on the disturbance variables 8 (FIG. 2) at the joint. By way of example, it would not be possible with the existing sensor system (detection device 30) for a gap in a connection between multiple components 5, 6, in particular a multi-sheet connection, to be assigned to a joining plane.

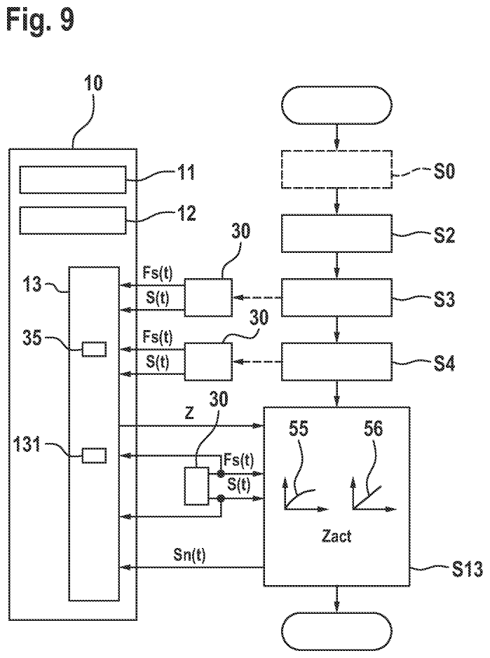

Instead of steps S8, S9, and S12 in the hold-off time of a welding process according to FIG. 8 or as an alternative to step S12 in FIG. 8, at least one step S13 of a method in FIG. 9 can be performed.

The method in FIG. 9 performs an in-situ compensation of the mechanical tong properties Z during a welding time T of a welding process.

According to FIG. 9, after the start of the method, the optional step S0 and steps S2 to S4 are performed again, as described with reference to FIG. 7. Accordingly, the welding tool 21 is arranged on at least one component 5, 6 and a force Fs>0 N is applied so that the predetermined force Fs is reached with which a welding process is to be started. The flow then continues to step S13.

In step S13, a real-time calculation is performed during the welding time T. Accordingly, a welding current Is is supplied to the electrodes 22, 23, as shown by way of example in FIG. 5 and FIG. 6. Furthermore, the control apparatus 10, in particular its determination module 11, performs a calculation simultaneously or in real time to calculate and compensate for the current tong characteristics Zact. For this purpose, the control apparatus 10, in particular its determination module 11 and/or force module 12, uses the tong properties Z stored in the memory module 13 as well as the real-time force signal Fs(t) of the welding tool 21 and the real-time displacement signal S(t) of the welding tool 21 and calculates the influence of the current tong properties Zact on the displacement signal S(t) using Equation (1) and/or Equation (3). As an alternative to using real-time signals, at least mutually synchronous signals Fs(t), S(t) are required. The detection device 30 detects the real-time force signal Fs(t) and the real-time displacement signal S(t) in real time during the ongoing welding process and outputs them to the control apparatus 10. After calculating the current tong characteristics Zact, the control apparatus 10, in particular its determination module 11 and/or force module 12, calculates the difference between the calculated influence on the displacement signal S(t) and the real-time displacement signal S(t). As a result, the control apparatus 10, in particular its determination module 11 and/or force module 12, receives the compensated displacement signal Sn(t), shown by way of example in FIG. 5 and FIG. 6. The control apparatus 10 uses the normalized displacement signal Sn(t) to regulate the welding process. The control apparatus 10 performs the calculations and regulation of step S13 until the welding time T is terminated.

After the welding time T has elapsed, the method in FIG. 9 is terminated. Alternatively, the flow can go back to step S0.

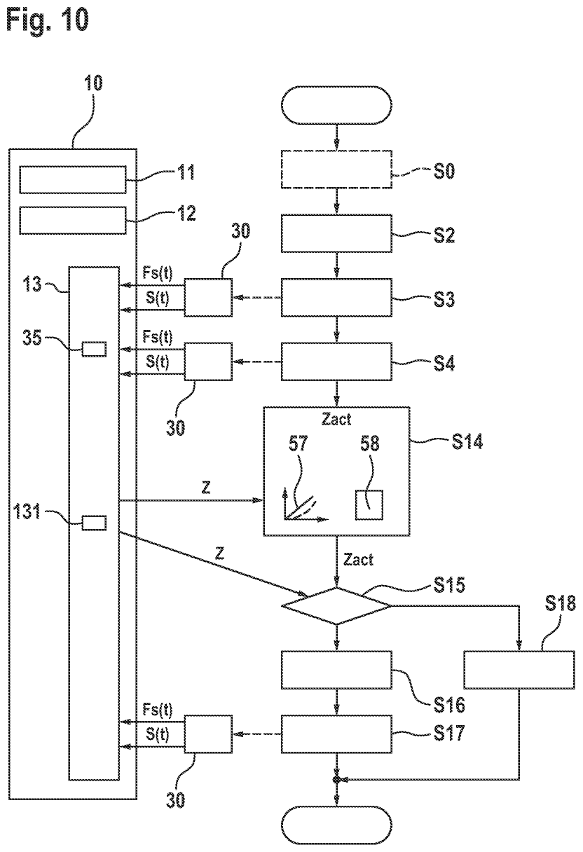

Optionally, in addition to at least one of the methods in FIG. 8 or FIG. 9, in particular their steps S8 to S13, a method according to FIG. 10 can be performed.

The method in FIG. 10 is used to compensate for the mechanical tong properties Z of the welding tool 21 based on information about disturbance variables 8 during a welding process.

The method in FIG. 10 performs an in-situ compensation of the mechanical tong properties Z based on additional information about the upcoming welding process.

According to FIG. 10, after the start of the method, the optional step S0 and steps S2 to S4 are performed again, as described with reference to FIG. 7. Accordingly, the welding tool 21 is arranged on at least one component 5, 6 and a force Fs>0 N is applied so that the predetermined force Fs is reached with which a welding process is to be started. The flow then continues to step S14.

In step S14, the control apparatus 10, in particular its determination module 11, performs a calculation of the current tong properties Zact before welding, i.e. without a welding current Is being supplied, as previously described with reference to step S8 in FIG. 8. The calculated current or instantaneous tong properties Zact during force buildup in steps S3 and S4 as well as the ascertained characteristic values of the welding tool 21 are thereby known. In addition, the control apparatus 10, in particular its determination module 11, generates a stiffness model 58 of the joint. For this purpose, the control apparatus 10 forms a difference of the stored tong characteristics Z and the current tong characteristics Zact. On this basis, information 57 on disturbance variables 8 and tong wear, in particular wear of the electrode caps 220, 230, is derived. The flow then proceeds to step S15 to evaluate the difference of the stored clamp properties Z and the current tong properties Zact.

In step S15, it is checked whether the difference of the stored tong properties Z and the current tong properties Zact has a value for which the disturbance variable(s) 8 is/are recoverable or not. If the disturbance variable(s) 8 is/are correctable, then the flow proceeds to step S16. Otherwise, i.e., if the disturbance variable(s) 8 is/are not correctable, the flow proceeds to step S18.

In step S16, the control apparatus 10, in particular its determination module 11, performs a compensation of the disturbance variable 8. For this purpose, the control apparatus performs, e.g., a change in the hold-off force/welding time (gap) and/or a change in the welding current/time. Both the amplitude of the hold-off force Fs and/or the welding time T and/or the amplitude of the welding current Is can be changed at desired times. The flow then continues to step S17.

In step S17, the control apparatus 10, in particular its force regulation module 12, performs a welding process with the changed welding current Is(t) and/or the changed force Fs(t) and/or the changed welding time T. The signals Fs(t) and S(t) detected in real time are stored in the memory module 13. The control apparatus 10 performs the regulation of step S17 until the welding time T is terminated.

After the welding time T has elapsed, the method in FIG. 10 is terminated. Alternatively, the flow can go back to step S0 or step S2.

If the disturbance variable(s) 8 cannot be eliminated, the welding process is aborted in step S18 or no welding current Is is supplied. The control apparatus 10 outputs a message 48, in particular a warning message and/or error message, by means of the operating device 40 (FIG. 1). The error message can be in particular “Gap in joining plane”. In addition, it can be specified in which joining plane the gap is present. This is particularly advantageous for multi-component connections.

The method in FIG. 10 is then terminated.

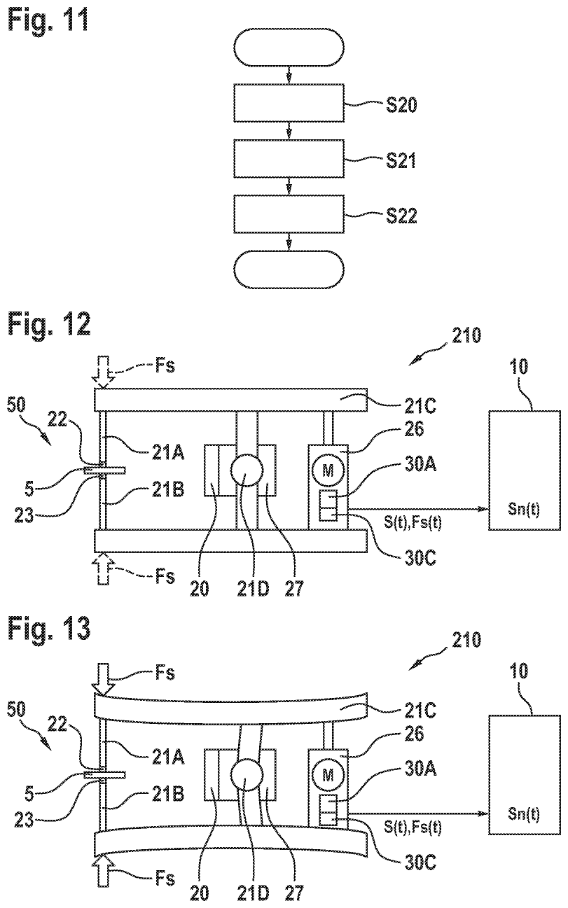

FIG. 11 illustrates a method for performing a cleaning or service process using the cleaning device 60.

After starting the method, a compensation of the influence of the mechanical properties of the welding tool 21 or the mechanical properties of the cleaning device 60 (FIG. 2) is performed in step S20. For this purpose, the welding apparatus, in particular its determination module 11, proceeds as described with respect to the method in FIG. 9. Accordingly, the influence of the welding tool 21 on the displacement signal S(t) is calculated from the real-time force signal Fs(t) and the real-time displacement signal S(t) of the welding tong (welding tool 21), and the compensated displacement signal Sn(t) is generated. The control apparatus 10 then uses the compensated displacement signal Sn(t) as a further command variable in the force regulation of the welding tool 21 during the cleaning process or service process. The flow then continues to step S21.

In step S21, the detection device 30 detects a chip removal at the electrode caps 220, 230 (FIG. 2) based on the force regulation that the control apparatus 10, in particular its force regulation module 12, performs for the welding tool 21 during a cleaning process or service process. The detection runs until the predetermined chip removal is achieved. The flow then continues to step S22.

In step S22, the cleaning process or service process is aborted or terminated.

The method in FIG. 11 is then terminated.

As a result, as a work process, the apparatus 10 can very advantageously perform not only a welding process, but also a service process, taking into account the mechanical tong characteristics Z or Zact of the welding tool 21.

FIG. 12 and FIG. 13 show a welding tool 210 that can be used instead of the welding tool 21 in FIG. 1 to FIG. 4 in the welding facility 2 in FIG. 1, according to a second exemplary embodiment.

FIG. 12 shows a state where Fs=0 N. This is comparable to the state of the tool 21 in FIG. 3. FIG. 13 shows a state in which the predetermined pressing and holding force Fs acts on the electrodes 22, 23. This is similar to the state of the tool 21 in FIG. 4.

The welding tool 210 is a welding tong, which is formed as an X-tong. The welding tool 210 has two tong arms 21A, 21B arranged on a stationary frame 21C or a tool guide system or a tool holder supported at a fixed point with the tool guided by hand). The tool guidance system is, e.g., the apparatus 20 in FIG. 1, in particular a robot. Both tong arms 21A, 21B of the welding tool 210 are movable arms.

The drive device 26 has a motor with integrated sensors 30B, 30C for the detection device 30 (FIG. 1). Alternatively, the drive device 26 is arranged external to the welding tool 210. The sensor 30C is a torque sensor 30C for detecting the torque M of the motor of the drive device 26. The applied torque M of the motor is proportional to the generated force Fs. Thus, the torque sensor 30C indirectly detects the force Fs acting on the arms 21, A, 21B and thus the electrodes 22, 23.

Also in the case of the welding tool 210, arm bending up or deflection of the frame 21C occurs in the state in FIG. 13, as visible in the comparison with FIG. 12.

Therefore, the control apparatus 10 is designed to also compensate for the real-time displacement signal S(t) for the welding tool 210, as described with respect to the first exemplary embodiment.

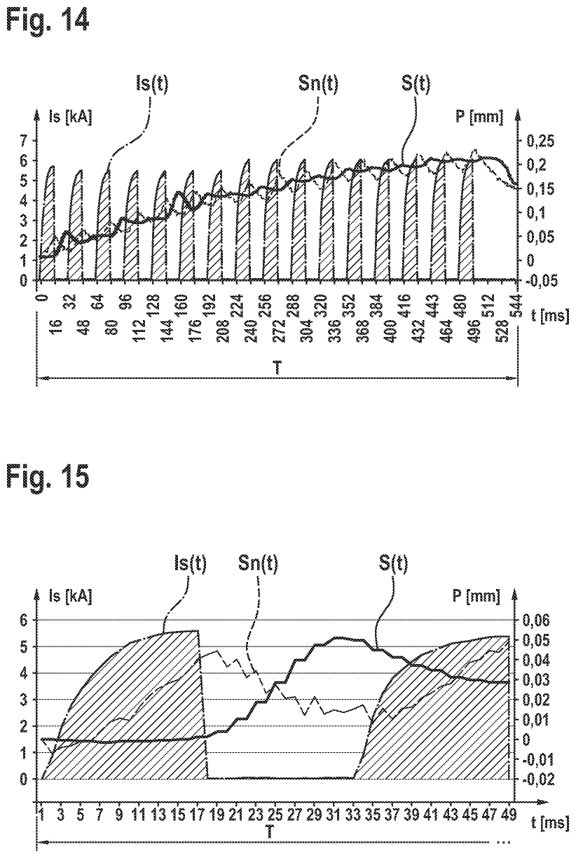

The control apparatus 10 can generate a compensated or normalized displacement signal Sn(t) as needed for welding using the welding tool 210. This results in the example of a welding current Is shown in FIG. 14 and FIG. 15, e.g., in a course of the displacement signals S(t), Sn(t) as shown in FIG. 14 and FIG. 15. FIG. 14 and FIG. 15 correspond to the illustration in FIG. 5 and FIG. 6, so that reference is made to the description.

The control apparatus 10 is in this case designed to use the tong properties Z previously ascertained for the welding tool 21 when ascertaining the tong properties Zact for the welding tool 210.

The control apparatus 10 is thereby designed to transfer the mechanical tong characteristics Z previously ascertained for the welding tool 21 to the welding tool 210.

Moreover, the control apparatus 10 can also perform such a transfer to any other tong system and/or any other tong-like tool. In particular, a transfer to a C-welding tool is also possible, in which at least one element of the tong geometry is changed compared to the welding tool 21 in FIG. 1 to FIG. 4. Alternatively, the control apparatus 10 can transfer the mechanical tong characteristics Z, ascertained by such transfer then for the welding tool 210, to a C-tong or other tong-like tool.

As a result, only one welding tool 21 or 210 needs to be set up for the control apparatus 10 when the welding facility 2 is put into operation. As a result, the initial operation of the welding facility 2 is significantly simplified. This results in a major advantage over the prior art, in which it is not possible to transfer and compare displacement reference curves to other tong systems, since the mechanical tong properties (force generation, tong deflection, tong springback, etc.) are reflected in the displacement signal and no compensation is provided for this.

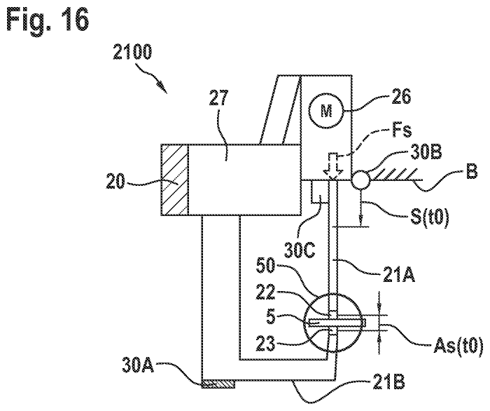

FIG. 16 shows a welding tool 2100 according to a third exemplary embodiment, which can be used instead of the welding tool 21 in FIG. 1 to FIG. 4 in the welding facility 2 in FIG. 1. The welding tools 21, 2100 are C-welding tongs.

FIG. 16 shows a state where Fs=0 N. This is comparable to the state of the tool 21 in FIG. 3.

In the welding tool 2100, the detection device 30 also comprises a torque sensor 30C for detecting the torque of the motor of the drive device 26. The torque sensor 30C is arranged on the movable tong arm 30C. The applied torque of the motor M is in this case proportional to the generated force Fs. The torque sensor 30C therefore indirectly detects the force Fs on the movable arm 21A. The force sensor 30A, on the other hand, directly detects the force Fs on the stationary arm 21A.

As a result, the tong stiffness model generated in the control apparatus 10 can be separately extended to the respective tong arm 21A, 21B, as previously described with reference to FIG. 7 in particular. In addition, this enables the control apparatus 10 to perform a detailed description, in particular a determination, of the force flow in the joint and a possible force flow into the at least one component 5, 6 to be joined is described and thus determined.

The control apparatus 10 therefore provides the additional option of improving the methods described with respect to the preceding exemplary embodiment.

Tests regarding the compensation of the tong influence on the force regulation using the control apparatus 10, in particular its force regulation module 12, showed that the signal quality could be significantly improved and that the reference system 50 (“distance between the electrodes 22, 23”) is described or determined more accurately.

As a result, every welding process or service process can be monitored and regulated in a more targeted manner. In addition, the detected signals Fs(t), S(t), and M(t) can be compared independently of the tong-shaped tool used.

All of the previously described embodiments of the welding facility 2, the control apparatus 10, the determination module 11, the force regulation module 12 and the method can be used individually or in all possible combinations. In particular, all features and/or functions of the previously described exemplary embodiments can be combined in any desired manner. In addition, the following modifications in particular are conceivable.

The parts shown in the drawings are schematic and may differ in exact design from the designs shown in the drawings as long as their previously described functions are guaranteed.

Optionally, the welding tools 21, 2100 can feature a corresponding introduction of forces FS on both sides, i.e., not only on electrode 22 or only on electrode 23, but over both electrodes 22, 23.

It is also possible to use a PD controller or a controller other than a PD controller for the force regulation module 12. It is in this case alternatively possible that multiple controllers be connected in series in the force regulation module 12. If, for example, a two-point controller is used instead of a PD controller, a less dynamic and less advantageous regulation solution would be created than with a PD controller.

The tong-shaped tool 21, 210, 210 need not be a welding tong, but can be a tong for performing some other work process, in particular a joining process. A joining process can, e.g., be clinching or self-pierce riveting.

The welding tong in FIG. 3 or 12 or 16 can also be used to perform a milling process on the electrodes 22, 23 using the cleaning apparatus 60, as previously described with respect to FIG. 11.

In addition, a tong-shaped tool 21, 210, 210 can be used for another work process, in particular a transport of an object.

What is claimed is:

1. An apparatus for position regulation of a tong-shaped tool, comprising:
a determination module configured to determine a normalized displacement signal, in which a deflection of the tong-shaped tool due to an effect of a mechanical force generated on the tong-shaped tool during a work process using the tong-shaped tool is compensated for; and
a force regulation module configured to regulate a progression of the force which the tong-shaped tool exerts on at least one component during the work process based on the normalized displacement signal.

2. The apparatus according to claim 1, wherein the normalized displacement signal comprises positions of a displacement, along which an element of the tong-shaped tool travels during the work process of the tong-shaped tool.

3. The apparatus according to claim 1, wherein the work process is (i) a force scaling without a component, (ii) a short-circuit welding without a component, (iii) a cleaning, or (iv) a milling of welding electrode caps of the tong-shaped tool.

4. The apparatus according to claim 1, wherein:
the work process is a joining process for producing a joined connection using the tong-shaped tool, and
the joining process is (i) a welding process for producing a welded connection using the tong-shaped tool, (ii) a riveting process, or (iii) a clinching process.

5. The apparatus according to claim 4, wherein the force regulation module is configured to regulate the progression of the force during the production of the joined connection using the normalized displacement signal.

6. The apparatus according to claim 4, wherein the determination module is configured to determine the normalized displacement signal from a progression of a force detected in real time and a displacement detected in real time, along which an element of the tong-shaped tool travels before and/or during performance of the joining process.

7. The apparatus according to claim 1, wherein the determination module is configured to determine the normalized displacement signal from a real-time detected progression of a force and a real-time detected displacement along which an element of the tong-shaped tool travels in order to perform the work process.

8. The apparatus according to claim 1, wherein the normalized displacement signal comprises positions of a displacement along which an element of the tong-shaped tool travels during a joining process in which a joined connection is produced, or during a service process in which the tong-shaped tool is cleaned or put into operation.

9. The apparatus according to claim 2, wherein:
the determination module is configured to calculate mechanical tong properties of the tong-shaped tool, and
the determination module is configured to use the mechanical tong characteristics to determine the normalized displacement signal from the progression of the force detected in real time and a displacement signal detected in real time for the displacement.

10. The apparatus according to claim 1, wherein:
the determination module is configured to use mechanical tong characteristics of a first tong-shaped tool for determining a normalized displacement signal of a second tong-shaped tool, and
mechanical tong properties of the second tong-shaped tool differ from the mechanical tong properties of the first tong-shaped tool.

11. The apparatus according to claim 1, wherein:
the apparatus is configured to evaluate a stiffness model of a joint, and
the apparatus is configured to abort the currently performed work process when the evaluation of the stiffness model of the joint shows that at least one disturbance variable and/or a predetermined tong wear are/is present.

12. The apparatus according to claim 11, wherein the apparatus is configured to output a message when the evaluation of the stiffness model of the joint shows that at least one disturbance variable and/or a predetermined tong wear are/is present.

13. A welding facility, comprising:
a welding tool including a welding tong having two electrodes configured to produce a welded connection on at least one component;
a drive device configured to drive the welding tool in order to apply a force which the two electrodes exert on the at least one component when producing the welded connection;
at least one force sensor attached to a stationary arm of the welding tool and/or to a movable arm of the welding tool, wherein the movable arm is movable relative to the stationary arm; and
an apparatus for position regulation of the welding tool, the apparatus including (i) a determination module configured to determine a normalized displacement signal, in which a deflection of the welding tong due to an effect of a mechanical force generated on the welding tong during a work process using the welding tool is compensated for, and (ii) a force regulation module configured to regulate a progression of the force which the welding tong exerts on the at least one component during the work process based on the normalized displacement signal.

14. A method for regulating a position of a tong-shaped tool, the method comprising:
determining, using a determination module, a normalized displacement signal, in which a deflection of the tong-shaped tool due to an effect of a mechanical force generated on the tong-shaped tool during a work process using the tong-shaped tool is compensated for; and
regulating, using a force regulation module, a progression of the force which the tong-shaped tool exerts on at least one component during the work process based on the normalized displacement signal.

15. The method according to claim 14, wherein the determining and the regulating are performed at least intermittently while performing the work process.
